(19) United States
(12) Patent Application Publication
(10) Pub. No.: US 2016/0140473 A1
(43) Pub. Date: May 19, 2016

(54) CREATING AND DISPLAYING A WORK SEQUENCE

(71) Applicant: ENSEMBLE PARTNERS PTY LIMITED, New South Wales (AU)

(72) Inventors: David Hodes, New South Wales (AU); Charles Leinbach, New South Wales (AU)

(21) Appl. No.: 14/898,463

(22) PCT Filed: Jun. 10, 2014
(86) PCT No.: PCT/AU2014/050067

§ 371 Date: Dec. 14, 2015

(30) Foreign Application Priority Data
Jun. 14, 2013 (AU) 2013902149

(51) Int. Cl. G06Q 10/06; G06Q 10/10

(52) U.S. Cl. CPC G06Q 10/06316; G06Q 10/1097

(57) ABSTRACT

A computer system for creating a work sequence of work items comprises a linked list storage to store multiple first work items and links between the first work items and a first-in-first-out buffer to buffer unscheduled second work items defining a first-out unscheduled second work item. The computer system further comprises a processor. The processor retrieves the first-out unscheduled second work item from the buffer and selects two of the first work items such that an available time between the two of the first work items is greater or equal to the duration of the first-out unscheduled second work item, and stores a link between the first-out unscheduled work item and each of the two selected first work item such that the stored link defines a work sequence and the first-out unscheduled work item is between the two first work items in the work sequence.

### TECHNICAL FIELD

This disclosure relates to creating a work sequence of work items. In particular, but not limited to, this disclosure relates to methods, software and computer systems for creating a work sequence of work items.

### BACKGROUND ART

Companies, government organizations and community charities perform a wide variety of work to achieve their missions. The characteristics of this work are different, so these different kinds of work are managed in different systems that are difficult to integrate.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

In a first aspect, there is provided a computer system for creating a work sequence of work items, the computer system comprising:
a linked list storage to store multiple first work items and links between the first work items such that the links represent a completion dependency between the first work items;
a first-in-first-out buffer to buffer unscheduled second work items defining a first-out unscheduled second work item, each of the unscheduled second work items being associated with a duration;
a processor
   to retrieve the first-out unscheduled second work item from the buffer,
   to select two of the first work items such that an available time between the two of the first work items is greater or equal to the duration of the first-out unscheduled second work item, and
to store in the linked list storage a link between the first-out unscheduled work item and each of the two selected first work item such that the stored link defines a work sequence and the first-out unscheduled work item is between the two first work items in the work sequence.

It is an advantage that work items stored in a linked list and work items stored in a FIFO buffer are combined. These conceptually different types of work items are stored in a unified way and a work sequence can be determined that comprises both types of work items. As a result, the combined workload of a worker from both types of work items can be easily monitored by reviewing the work sequence for that worker. Workloads and work sequences of multiple workers can be aggregated since the work sequences consider both types of work items and no separate monitoring systems are required for the different types of work items.

The first work items may be Gantt type work items and the second work items may be pull system type work items.

Each of the selected two of the first work items may be associated with a start time defining an earlier first work item and a later first work item of the selected two of the first work items.

The processor may be to determine a start time for the first-out unscheduled second work item based on the start time and duration of the earlier first work item.

The processor may be to determine a start time for the first-out unscheduled second work item based on the duration of the first-out unscheduled second work item and the start time of the later first work item.

The processor may be to create a calendar view comprising a graphical representation for each of the first work items and each of the second work items such that a location of each graphical representation is indicative of the start time of the respective first and second work items.

The computer system may further comprise a first input port to connect to a first separate database storing the first work items and to receive the first work items from the separate database wherein the processor may be to create and store the links between the received first work items in the linked list storage.

The computer system may further comprise a second input port to connect to a second separate database storing the second work items and to receive the second work items from the second separate database wherein the processor may be to store the received second work items in the first-in-first-out buffer.

The computer system may further comprise a calendar storage to store multiple calendar work items, each of the calendar work items being associated with a start time and an end time.

The computer system may further comprise a third input port to receive completion data associated with a completed work item and the processor is to perform the steps of retrieving, selecting and storing in response to receiving the completion data.

In a second aspect, there is provided a computer-implemented method for creating a work sequence of work items, the method comprising:
receiving from a linked list storage a linked list of multiple first work items comprising links between the first work items such that the links represent a completion dependency between the first work items;
receiving a first-out unscheduled second work item from a first-in-first-out buffer of multiple unscheduled second work items, each of the unscheduled second work items being associated with a duration;
selecting two of the first work items such that an available time between the two of the first work items is greater or equal to the duration of the first-out unscheduled second work item, and
storing in the linked list storage a link between the first-out unscheduled work item and each of the two selected first work item such that the stored link defines a work sequence and the first-out unscheduled work item is between the two first work items in the work sequence.

In a third aspect, there is provided software, that when installed on a computer causes the computer to perform the method of the second aspect.

In a fourth aspect, there is provided a computer system for displaying a work sequence, the computer system comprising:
a linked list storage to store first work items and links between the first work items such that the links represent a completion dependency between the first work items;
a first-in-first-out buffer to buffer unscheduled second work items defining a first-out unscheduled second work item, each of the unscheduled second work items being associated with a duration;
a processor
   to retrieve the first-out unscheduled second work item from the buffer,
   to select two of the first work items such that an available time between the two of the first work items is greater or equal to the duration of the first-out unscheduled second work item, and
a display
   to display a graphical representation of the first-out unscheduled work item located in relation to a graphical representation of each of the two selected first work item such that the location defines a work sequence and the first-out unscheduled work item is between the two first work items in the work sequence.

In a fifth aspect, there is provided a method for displaying a work sequence, the method comprising:
receiving from a linked list storage a linked list of multiple first work items comprising links between the first work items such that the links represent a completion dependency between the first work items;
receiving a first-out unscheduled second work item from a first-in-first-out buffer of multiple unscheduled second work items, each of the unscheduled second work items being associated with a duration;
selecting two of the first work items such that an available time between the two of the first work items is greater or equal to the duration of the first-out unscheduled second work item, and
displaying a graphical representation of the first-out unscheduled work item located in relation to a graphical representation of each of the two selected first work item such that the location defines a work sequence and the first-out unscheduled work item is between the two first work items in the work sequence.

In a sixth aspect, there is provided software, that when installed on a computer causes the computer to perform the method of the fifth aspect.

Optional features described of any aspect, where appropriate, similarly apply to the other aspects also described here.

### BRIEF DESCRIPTION OF DRAWINGS

An example will now be described with reference to:

FIG. 1 illustrates a computer system for creating a work sequence of work items.

FIG. 2 illustrates a computer-implemented Planning Board method for creating a work sequence of work items.

FIG. 3 illustrates an exemplary expected utilization with only Gantt work.

FIG. 4 illustrates the exemplary utilization of FIG. 3 with service work added.

FIG. 5 illustrates work for different staff with finance skills.

FIG. 6 illustrates the back-end of the Planning Board.

FIG. 7 illustrates an example of a user interface.

FIG. 8 illustrates a user interface for reprioritizing service work.

FIG. 9 illustrates a user interface for assigning service work items.

FIG. 10 illustrates a user interface for creating work items.

### BEST MODE FOR CARRYING OUT THE INVENTION

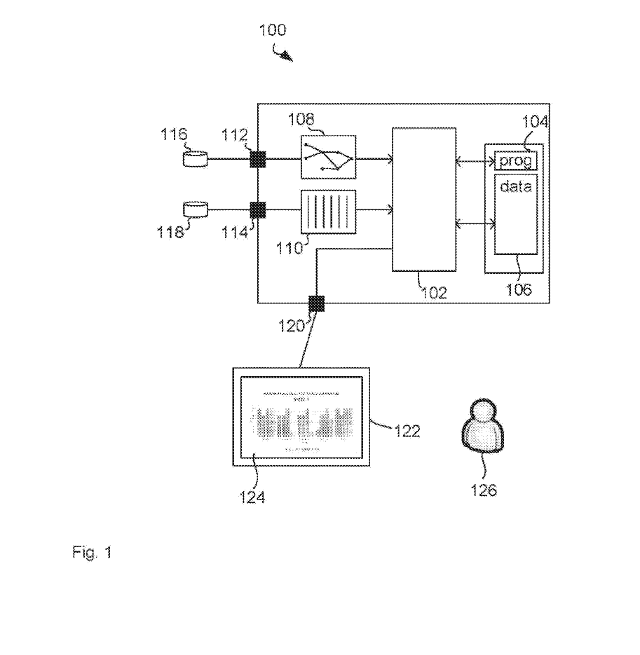

FIG. 1 illustrates a computer system 100 for creating a work sequence of work items. The computer system 100 includes a processor 102 connected to a program memory 104, a data memory 106, a linked list storage 108 and a first-in-first-out buffer (FIFO) 110. Although the linked list storage 108 and the FIFO buffer are shown as separate entities, it is to be understood that they may also be part of data memory 106.

The processor is further connected to a first data port 112 and a second data port 114, which are connected to first database 116 and second database 118, respectively. The processor is also connected to a user port 120 that interfaces the processor 102 with a display 122. In one example, the program memory 104 is a non-transitory computer readable medium, such as a hard drive, a solid state disk or CD-ROM.

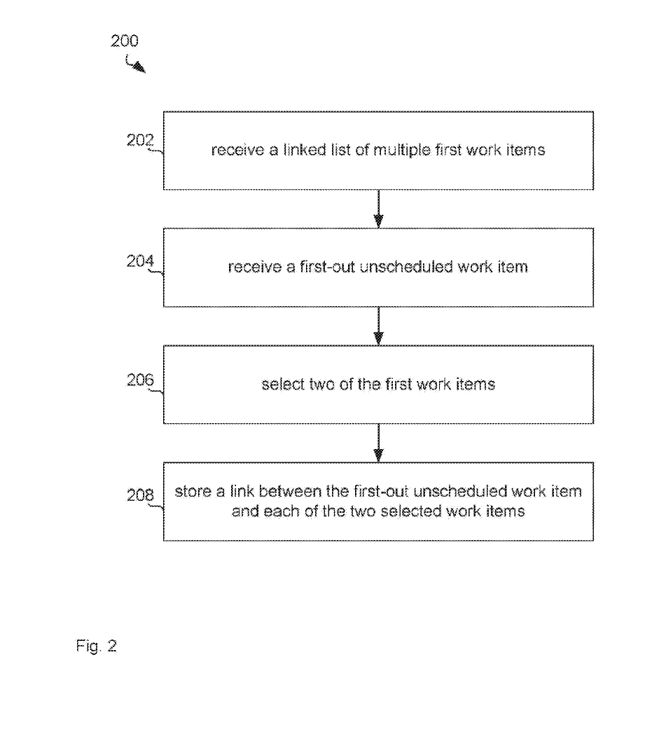

Software, that is an executable program comprising computer executable instructions, stored on program memory 104 causes the processor 102 to perform the method in FIG. 2, that is, the processor retrieves an unscheduled work item from the buffer, selects two work items from the linked list storage 108 and stores in the linked list storage a link between the unscheduled work item and each of the two selected work items as explained with reference to FIG. 2. The software on program memory 104 turns the computer system 100 into a practical planning tool for many professionals and is referred to as Planning Board.

In some examples, the processor 102 generates a graphical user interface 124, such as a calendar view, and causes the graphical user interface 124 to be displayed on display device 122 by sending appropriate commands and data to the display device 122. A user 126, such as a project manager, can view the user interface and plan the project accordingly.

FIG. 2 is to be understood as a blueprint for the Planning Board software program and may be implemented step-by-step, such that each step in FIG. 2 is represented by a function in a programming language, such as C++ or Java. The resulting source code is then compiled and stored as computer executable instructions on program memory 104.

In one example, linked list storage 108 is a computer memory that allows storing of items that are linked together. These items are work items and the links represent a completion dependency between the work items. For example, project management employs Gantt charts with work items that have a completion dependency. Therefore, the work items in the linked list storage 108 are referred to as Gantt type work items or simply Gantt items. For example, Alice's task is to design a product and Bob's task is to take photos of the prototype. Bob needs to wait until Alice has finished her task before he can begin his task. These two tasks are stored in the linked list storage 108 as two work items that have a link between them. This link may be directed to reflect the direction of dependency.

Gantt work is characterized by having many dependencies to other units of work that must be performed by a defined set of resources (people and assets). Gantt work is typically planned well in advance of its execution to optimize timing and resources utilization. In many examples, Gantt work is scheduled to align the sequence of work activities to the availability of the resources to perform the work. Any initiative of any substantial scale requires a computer system to perform this scheduling using optimization algorithms Examples of such Gantt work systems are Microsoft Project, Realization's Concerto, Primavera and Sciforma.

In one example, the Gantt work items in linked list storage 108 are already scheduled, which means that each Gantt work item is associated with a start time, for example, by storing the start time in the same record in an SQL database as the respective Gantt work item.

In many examples of large projects, multiple lists co-exist in the linked list storage 108. It may occur that the lists are connected, which means that a work item of one list is dependent on a work item of a different list. As a result, these two lists are connected and the linked list storage 108 stores a graph comprising the Gantt work items as nodes and the links as directed edges. The graph may be stored as an adjacency list or adjacency matrix in an SQL database.

In another example, FIFO buffer 110 is a computer memory that receives work items and allows the access of a work item in the order as they were received. That is, the first work item that is received by the buffer 110 is also the first work item that is accessed from the buffer 110. Since the work items in the buffer are not interconnected but are pulled from the buffer, they are referred to as pull system type work item. In some examples such work items represent service work.

Service work is characterized as work that has fewer dependencies and has priority as its defining attribute, which is reflected by the position in the FIFO buffer 110. Service work is sometimes defined well in advance of when it is executed, but more often than not it is defined “on demand”, with an expectation that the work will be performed as soon as possible. Examples of such work are a list issues for a project that must be managed to resolve project problems, or a list of maintenance tasks that must be performed to refurbish a machine. Activities such as these are often represented as stack of work cards in a system, where the work card on the top of the stack must be completed or assigned before the second card on the stack can be worked on. Systems that manage such work are often called “work ticket” systems or Kanban systems and include products such as the Task Lists of Microsoft Outlook/Exchange, Microsoft Sharepoint tasks, HP ALM Issues, and others.

Having different systems that manage the different types of work creates difficulty for management and individual workers. It is difficult to understand what resources will be required to perform all of the work of an organization or all of the work for an initiative, as these systems are not integrated and a unified work and resource picture cannot be obtained. Managers have a difficult time assigning work as assignments must be made in multiple systems. Workers must use multiple systems to know what work they are responsible for, and these systems very well may be in conflict.

The linked list storage 108 and the FIFO buffer 110 may be physically present on various different technologies, such as RAM, distributed cloud storage and hard disk drive, such as data memory 106. The processor 102 may receive and retrieve data, such as work items, from data memory 106 or via communications port (not shown), such as by using a Wi-Fi network according to IEEE 802.11. The Wi-Fi network may be a decentralised ad-hoc network, such that no dedicated management infrastructure, such as a router, is required.

It is to be understood that any kind of data port may be used to receive and retrieve data, such as a network connection, a memory interface, a pin of the chip package of processor 102, or logical ports, such as IP sockets or parameters of functions stored on program memory 104 and executed by processor 102. These parameters may be handled by-value or by-reference in the source code. The processor 102 may receive data through all these interfaces, which includes memory access of volatile memory, such as cache or RAM, or non-volatile memory, such as an optical disk drive, hard disk drive, storage server or cloud storage. The computer system 100 may further be implemented within a cloud computing environment, such as a managed group of interconnected servers hosting a dynamic number of virtual machines.

FIG. 2 illustrates a computer-implemented Planning Board method 200 for creating a work sequence of work items as performed by processor 102 executing software stored on program memory 104. The processor 102 commences performing the method 200 by receiving 202 from the linked list storage 108 a linked list of multiple Gantt work items. As explained earlier, the linked list comprises links between the Gantt work items such that the links represent a completion dependency between the Gantt work items.

The processor then receives 204 a first-out unscheduled service work item from the FIFO buffer 110 of multiple unscheduled service work items. Each of the unscheduled service work items is associated with a duration, that is, a time value that describes how long the service work is expected to take.

Once the Gantt work items and the service work item are available, the processor 102 selects 206 two of the Gantt work items such that an available time between the two of the Gantt work items is greater or equal to the duration of the first-out unscheduled service work item. This step will be explained in more detail in an example further below. If no two such work items can be found then the service work item is placed at the end of all of the Gantt work items.

As a final step the processor 102 stores 208 in the linked list storage a link between the first-out unscheduled service work item and each of the two selected Gant work items such that the stored link defines a work sequence and the first-out unscheduled service work item is between the two Gant work items in the work sequence.

The following example illustrates the process of the Planning Board.

Bob, an analyst, is one of many people working on project Leverage, an initiative to design a new fulfillment process. He has expertise in finance and is qualified to perform certain tasks on the project. Project Leverage has a project plan that is managed in Microsoft Project Enterprise (MPE), a Gantt system.

MPE maintains a linked list storage 108 and therefore knows the sequence of work that must be performed to create this new system and it creates a schedule for the work to build the system. Bob has assignments from the system that tell him what work to perform and the timeframe in which it must be completed. MPE creates its schedule to optimize the time and resources required to build the system, but the nature of such systems is that many resources are not always completely utilized.

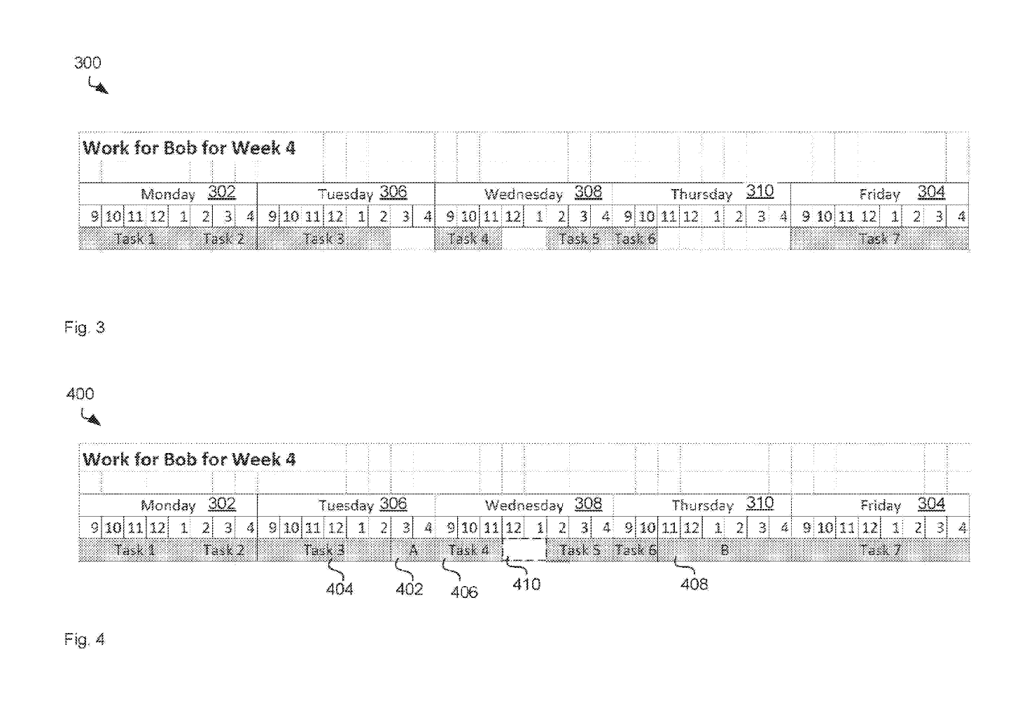

FIG. 3 shows Bob's expected utilization 300 for week 4 of the project. During this week Bob has a full day's of work to perform on Monday 302 and Friday 304, but his workload is less than complete for days Tuesday 306, Wednesday 308 and Thursday 310. The gaps in Bob's workload can best be explained by the dependencies of his tasks on other work that will be completed before the end of the gap. Bob has time available for other work.

Bob's company also has a FIFO buffer 110 as an issue tracking system for the project, a module of HP ALM. All of the project managers of project Leverage maintain and manage a list of the project issues in HP ALM. New issues are assigned to workers for resolution. The current list of prioritized issues includes the following issues that Bob has the skills to resolve:

| | | Effort | | | |
|---|---|---|---|---|---|
| Prior- | | Hours/ | Created | Assigned | Due |
| ity | Issue | Duration | Date | To | Date |
| 21 | Investigate quality | 2 | Jan. 5, | Unassigned | Jan. 6, |
| | issue with vendor | | 2013 | | 2013 |
| 26 | Clarify step 65a in | 6 | Jan. 7, | Unassigned | Jan. 10, |
| | replenishment | | 2013 | | 2013 |
| | process | | | | |
| 31 | Data in XYZ | 4 | Jan. 3, | Unassigned | Jan. 20, |
| | system needs | | 2013 | | 2013 |
| | validation | | | | |

Bob would have time during week 4 to resolve some of these issues. The processor 102 assigns these service work items to Bob.

FIG. 4 illustrates Bob's Utilization 400 for Week 4 with Service Work. Bob's service work has been added to the Gantt work in FIG. 3. Notice that the service work was added to Bob's schedule in the FIFO order, that is, the priority order listed in the service system. Processor 102 retrieves item 21 (reference numeral 402) as the first-out unscheduled service work item from the FIFO buffer 110 and item 21 is associated with an estimated duration of two hours. The processor 102 searches for two Gantt work items with an available time between them being greater or equal to two hours, that is, the duration of service work item 402. In the example of FIG. 4, processor 102 selects a first Gantt work item 404 and a second Gantt work item 406. This means the service work item 402 fits into the open 2 hours slot on Tuesday 306.

The technical process for placing the service work item 402 between the first Gantt work item 404 and second Gantt work item 406 is that the processor 102 stores a link between service work item 402 and Gantt work item 404 and between service work item 402 and Gantt work item 406. This link defines that the Gantt work item 404 comes first, then service work item 402 and finally Gantt work item 406. That is, the newly added links define a work sequence and the service work item 402 is between the Gantt work items 404 and 406 in the work sequence.

In examples where a gap between two Gantt work items is large enough to accommodate two or more service work items, two options are possible. First, two or more service work items may be combined and considered as a single service work item in FIFO buffer 110 with a duration being the sum of the combined service work items. This combined service work item is then integrated into the work schedule as described above.

Second, a first service work item is slotted between the Gantt work items in an as-soon-as-possible (ASAP) manner, leaving a gap between the service work item and the later Gantt work item. When the processor 102 stores a link between the service work item and the Gantt work items, the processor also stores the service work item into the linked list storage 108 and effectively transforms the unscheduled service work item into a scheduled work item similar to a Gantt work item. The next service work item can then be scheduled the same way and will be placed after the first service work item and before the later Gantt work item.

It is noted here that storing a link between work items in the linked list storage 108 may also comprise storing the work item in the linked list storage as well as breaking some existing links between Gantt work items. In the example of FIG. 4, the Gantt work items 404 and 406 are linked before the service work item 402 is slotted between them. Storing the links for service work item 402 to Gantt work items 404 and 406 comprises first deleting the link between Gantt work item 404 and Gantt work item 406.

The next item is 26 (reference numeral 408), which is estimated to be six hours, that is, has a duration of six hours. The first available slot for it is on Thursday 310. The decision to put item 31 in the open slot 410 on Wednesday 308 is left open to the user because inserting it in that slot would change the priority or order in which the tasks were worked.

In one example, the service work is not in fact tied to specific dates and times although it may appear that the service work is “scheduled” in the gaps of the Gantt work. Given the priority of service work, and a schedule of Gantt tasks, the planning board will show approximately when the service items will be worked and completed. The nature of the Gantt work is that it may shift due to tasks or dependent tasks completing early or running late. As the Gantt work shifts, so do the estimated dates and times of the service work.

In another example, the processor 102 determines a start time for the service work item 402 in order to display the service work item correctly on the user interface 400 in relation to a time range, such as in a calendar view.

In an as-soon-as-possible (ASAP) approach the processor 102 takes the start time of the earlier Gantt work item 404 and adds the duration of the Gantt work item 404. The result is the start time of the service work item 402. Of course, this addition takes into account the break between working days.

In an as-late-as-possible (ALAP) approach the processor 102 takes the start time of the later Gantt work item 406 and subtracts the duration of the current service work item 402. The result is the starting time of the service work item 402.

Displaying the Gantt and Service work is valuable, but integrating the two types of work allows workers and managers to reprioritize the service work. The nature of service work is that this is a typical way of handling service work.

Extending our example, Sue is a manager who is developing the new replenishment process. She realizes that issue 26 must be resolved by the end of the day on Tuesday 306 for her team to stay on schedule. However Bob does not have the time on Tuesday to resolve the issue. If Bob were to resolve the issue on Tuesday then it would likely delay his Tuesday 306 Gantt work, impacting the overall project schedule. Sue needs to have someone else perform the work.

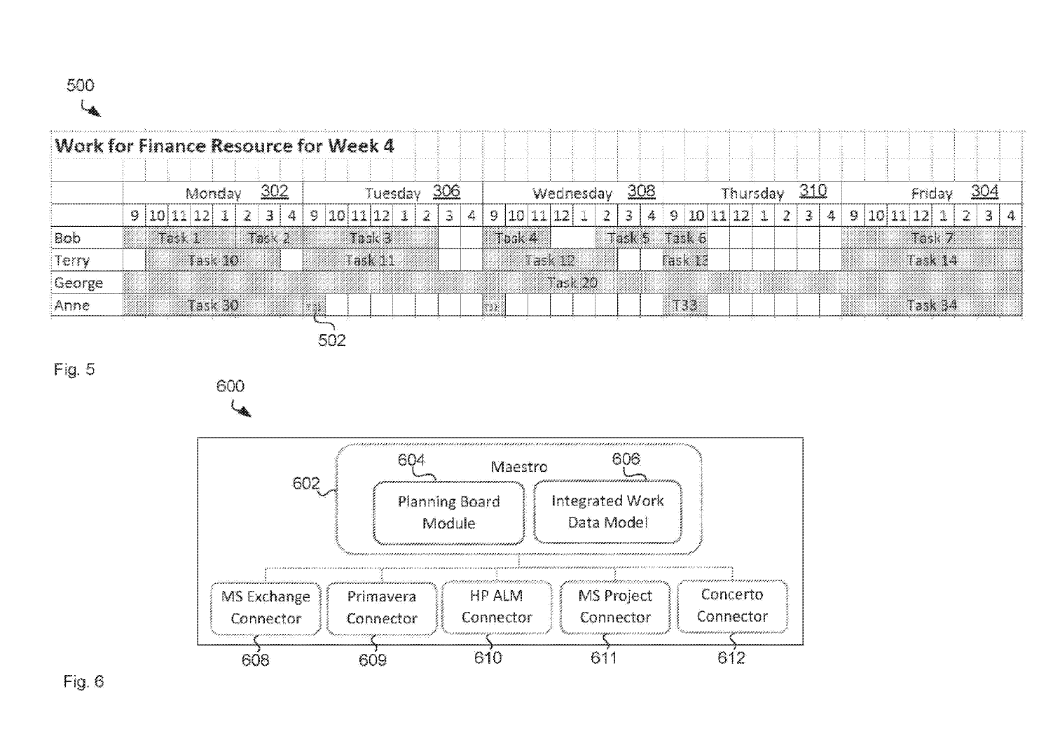

FIG. 5 illustrates work 500 for staff with finance skills for week 4. Sue views what is shown in FIG. 5, that is, Gantt utilization plans of a few staff members with finance skills. Sue can see that Anne only has one hour of Gantt work 502 on Tuesday 306. She can then reassign the service item 26 for Anne to perform.

The example above describes the nature of problem that the Planning Board solves:
Different types of work are integrated into a single model for viewing and gaining insight into all work that must be done
Service work can be managed—defined, assigned to workers, reassigned and updated by workers.

The Planning Board is a technical solution for integrating work systems and managing service work. It consists of back-end functions that retrieve work data and update that data. It also consists of a user interface that presents a unified view of work and allows uses to manage service work. The back-end and user interface will now be described in more detail.

### Back-End

FIG. 6 illustrates the back-end 600 of the Planning Board. The back-end 600 comprises a main module 602 including a Planning Board module 604 and work data model 606 and integration logic, plus a series of standardized connectors 608 to 612 that create the connections to source work systems. In one example, each of these modules is implemented as a separate class in C++.

The connectors 608 to 612 connect to external databases 116 and 118 in FIG. 1. For example, the Primavera connector 609 connects via first data port 112 to external Primavera database 116. The Primavera database stores Gantt work items and the processor 102 receives these Gantt work items through first data port 112 by the use of the Primavera connector 609. The processor 102 then creates and stores links between the Gantt work items in the linked list storage 108.

Similarly, processor 102 uses the HP ALM connector 610 to connect to a HP ALM database 118 via second data port 114. The HP ALM database 118 stores service work items. The processor 102 receives the service work items through the HP ALM connector 610 and stores the received service work items in the FIFO buffer 110.

Further, MS Exchange connector 608 connects to a Microsoft Exchange system to receive calendar items. The calendar items include scheduling information, such as start time and duration or end time. The processor 102 places the calendar items in the view where they are scheduled to be. In one example, the MS Exchange calendar connector 608 uses the same interface methods as the Gantt connector 609 and Service work connector 610.

The Planning Board back-end module is used by the user interface for accessing the aggregated work data, maintaining an integrated model of all work and performing actions on the connected work systems. It makes use of the following methods:

| Function | Parameters | Description |
|---|---|---|
| GetParticipants | Start date range | Returns a list of workers who |
| | End date range | are working for a given |
| | Manager | manager during a time frame |
| | | that is specified by the start |
| | | and end dates. This is used to |
| | | render the Planning Board |
| GetWorkForParticipant | Start date range | Returns a list of work items |
| | End date range | for a worker in the specified |
| | Worker | date range |
| GetQueueForManager | Manager | Returns a list of work items |
| | | that reside in a manager's |
| | | queue for assigning. |

In one example, all work items are cached in a table within a central database.

Work connectors 608 to 612 are standardized code libraries that implement an interface that allows the Planning Board to integrate work data. The interface supports basic functions to retrieve work, update work and retrieve work queue information.

| Function | Parameters | Description |
|---|---|---|
| GetWork | Start date range | Returns a list of work items for |
| | End date range | a worker within a date range |
| | Worker | |
| UpdateWork | Work Item | Updates a work item with new |
| | | information. Only applies to |
| | | service work. |
| GetQueueForManager | Manager | Returns a list of work items that |
| | | would reside in a manager's |
| | | queue. Only applies to |
| | | Service work connectors |

As mentioned in earlier in relation to FIG. 1, display device 122 displays a user interface 124 for the planning board.

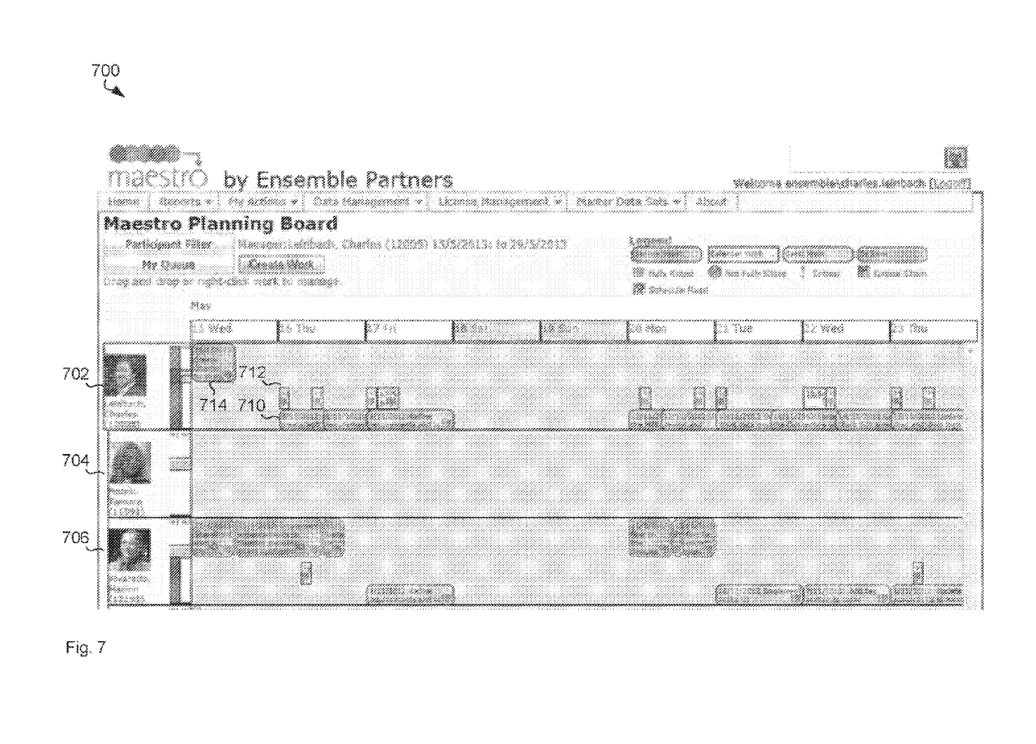

FIG. 7 illustrates an exemplary user interface 700 as displayed on display device 122. In this example we see a manager, Charles, 702 and two of his direct reports, Tamara 704 and Marlon 706. Each worker has a time-based swim lane that displays their work over a range of time—Wednesday, May 15 to Wednesday, May 29. Gantt work is displayed as graphical representations, such as bars, at the bottom of each swim lanes, such as first bar 710, that cover the scheduled time for each Gantt work task. The location of the bars in a left-to-right direction is indicative of the start time of the Gantt work items (and the other work items mentioned below)

Above the Gantt work items are Calendar items, such as calendar item 712. Calendar items are displayed by expected start and end times. They are used to get a full picture of work. Their start times are not changed to avoid conflicts with the other work, nor are the other work items' start times changed to accommodate the calendar work. As a result, calendar items may overlap with the other work items, such as calendar item 712 overlaps Gantt work item 710.

Finally the service work items, such as service work item 714, are placed between Gantt items in order of priority and as allowed by their expected efforts. Looking at this screen 700 gives Charles 702 a good idea of the work that his team is planning to execute in the upcoming week.

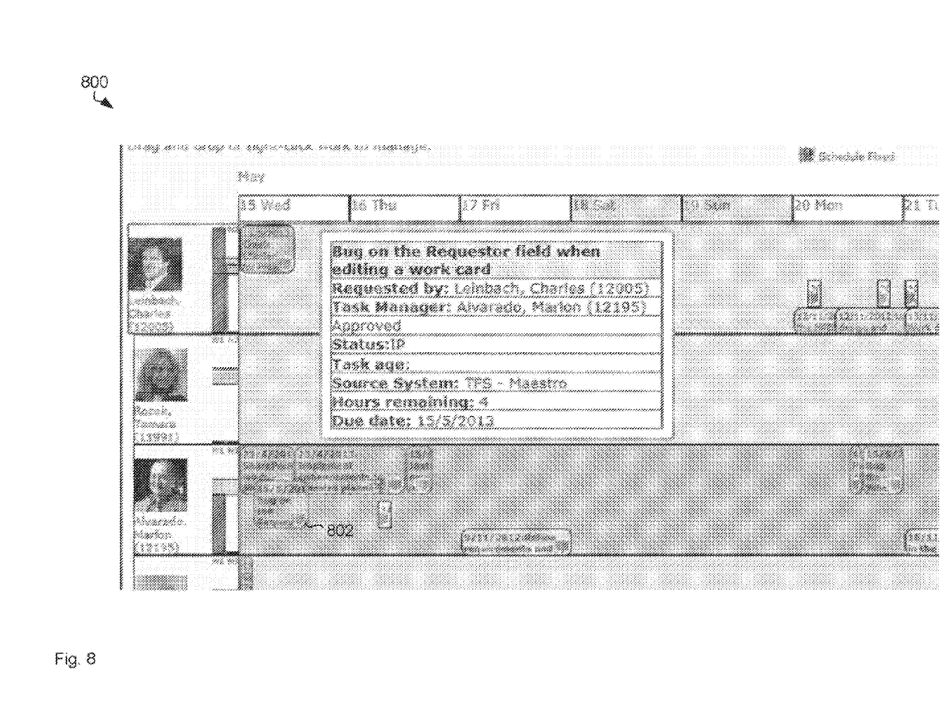

FIG. 8 illustrates a user interface 800 for reprioritizing service work. This is accomplished by rearranging the order of the service work items by dragging and dropping. For example, a manager from another team needs the first service task 802 that Marlon is planning to work on Monday the 20^{th} to be performed by the end of the day on Wednesday the 15^{th}. Charles can drag and drop that item 802 into the Wednesday space as shown below. The dragged service work item is placed before the item on which it was dropped. In technical terms, this means that in response to Charles's user input, processor 102 takes work items from the FIFO buffer 110, rearranges the work items according to the user input and places the work items back into FIFO buffer in the new order. Once the service work items are rearranged in the FIFO buffer, the method of FIG. 2 is re-executed and the user interface 124 updated accordingly.

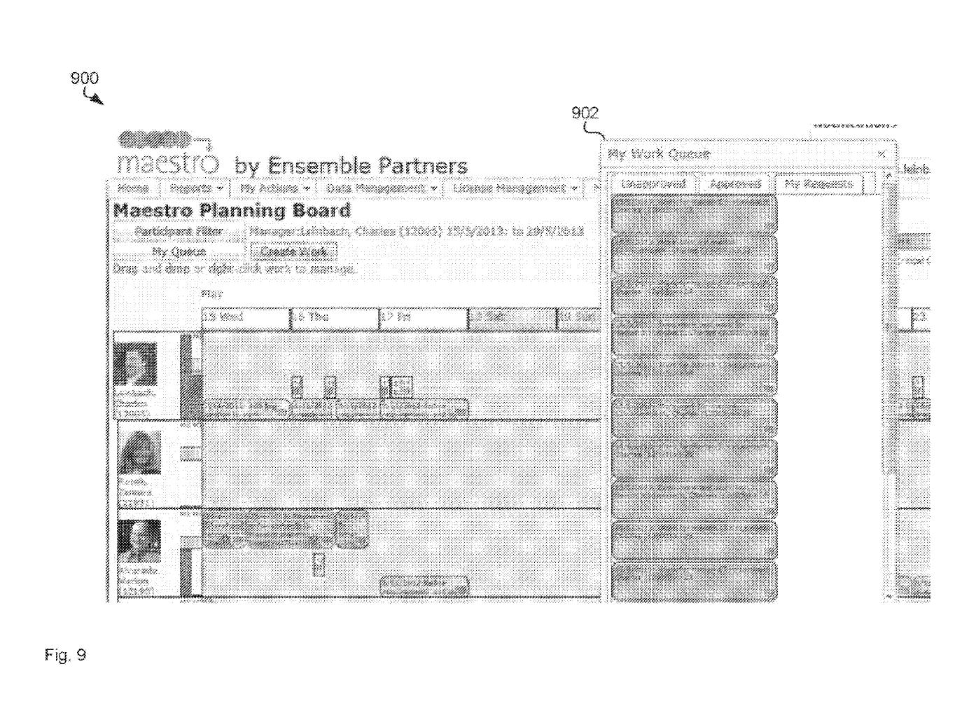

FIG. 9 illustrates a user interface 900 for assigning service work items. Service work systems utilize a queue 902 of unassigned work. Work items in the queue 902 are listed in priority and tasks are assigned to workers from this queue. The Planning Board creates an integrated queue of all of the service work systems for task assignment as shown in FIG. 9. Assigning work items from queue 902 to a particular person means that the work items are placed into the FIFO buffer 110 assigned to that person. This shows that although FIG. 1 only shows one FIFO buffer 110 and one linked list storage 108, there may be multiple FIFO buffers and multiple linked list storages, such as one for each person managed by the planning board computer system 100. Of course, multiple linked lists or FIFO buffers can be stored in a single table of an SQL database

A work integration environment such as the Planning Board may also support a function for creating work items.

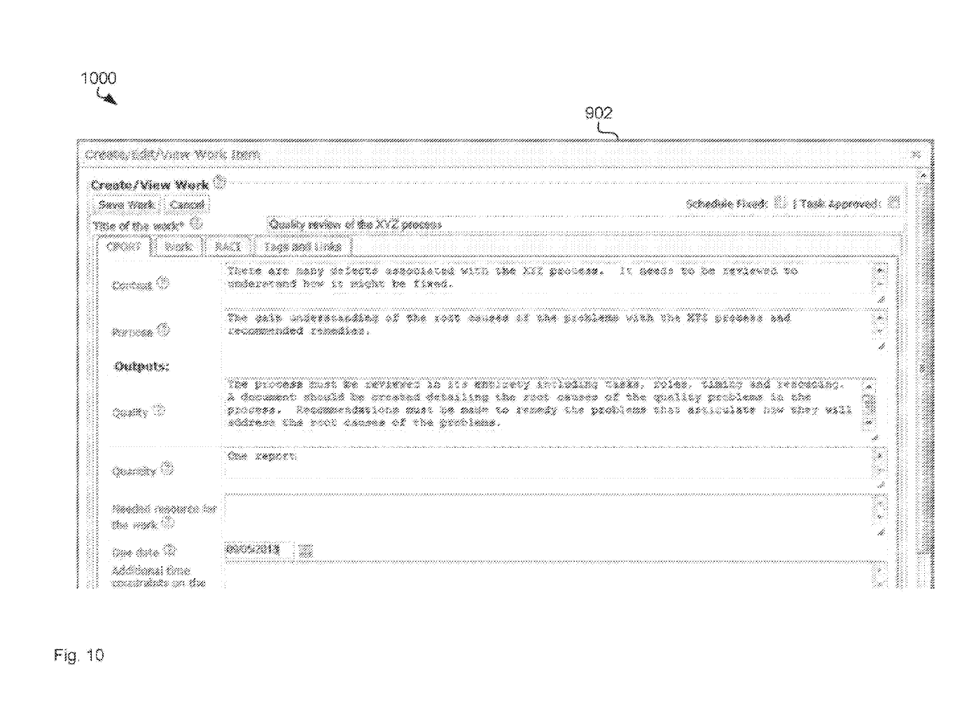

FIG. 10 illustrates a user interface for creating work items. Work items can be defined by clicking on the “Create Work” button on the Planning Board. This displays the Create/Edit/View Work item dialog 1000. This dialog 1000 allows workers and managers to define tasks in a detailed manner, allows them to request that the work be performed by a certain individual or individual with a specified skill. Workers also use this dialog to record which service work system to store the new record in if there are multiple service work systems.

Each time the user interface of the Planning Board is rendered it places the Gantt work items in the locations specified by the scheduled start and end dates as determined by their native scheduling systems and the calendar items as specified by the native calendar systems. It then inserts workers' service work items in the priority order they are recorded in the first available slots as explained with reference to FIG. 2.

As the users complete their work items, the project manger 126 or the individual users 702, 704 and 706 mark their work items as completed, such as by tapping the respective work item on a touch screen of display device 122. As a result, completion data is generated that is associated with a completed work item, such as by using a work item id and a flag that indicates this work item as completed. The processor 102 receives the completion data via user port 120 and repeats the scheduling of the work items. That is, the processor 102 retrieves a service work item from the FIFO buffer 110 and selects two Gantt work items to slot the service work item between the Gantt work items by storing links in the linked list storage 108 as explained before.

This logic makes the Planning Board rather dynamic—always showing an estimate of when service work will occur based on current system information. As work progresses and is completed those estimates change when the screen is refreshed.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “receiving” or “estimating” or “processing” or “computing” or “calculating” or “generating”, “optimizing” or “determining” or “displaying” or “maximising” or “equalising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

What is claimed:

1. A computer system for creating a work sequence of work items, the computer system comprising:
a linked list storage to store multiple first work items and links between the first work items such that the links represent a completion dependency between the first work items;
a first-in-first-out buffer to buffer unscheduled second work items defining a first-out unscheduled second work item, each of the unscheduled second work items being associated with a duration;
a processor
to retrieve the first-out unscheduled second work item from the buffer,
to select two of the first work items such that an available time between the two of the first work items is greater or equal to the duration of the first-out unscheduled second work item, and
to store in the linked list storage a link between the first-out unscheduled work item and each of the two selected first work items such that the stored link defines a work sequence and the first-out unscheduled work item is between the two first work items in the work sequence.

2. The computer system of claim 1, wherein the first work items are Gantt type work items.

3. The computer system of claim 1, wherein the second work items are pull system type work items.

4. The computer system of 1, wherein each of the selected two of the first work items is associated with a start time defining an earlier first work item and a later first work item of the selected two of the first work items.

5. The computer system of claim 4, wherein the processor is to determine a start time for the first-out unscheduled second work item based on the start time and duration of the earlier first work item.

6. The computer system of claim 4, wherein the processor is to determine a start time for the first-out unscheduled second work item based on the duration of the first-out unscheduled second work item and the start time of the later first work item.

7. The computer system of claim 4, wherein the processor is to create a calendar view comprising a graphical representation for each of the first work items and each of the second work items such that a location of each graphical representation is indicative of the start time of the respective first and second work items.

8. The computer system of claim 1, further comprising a first input port to connect to a first separate database storing the first work items and to receive the first work items from the separate database wherein the processor is to create and store the links between the received first work items in the linked list storage.

9. The computer system of claim 1, further comprising a second input port to connect to a second separate database storing the second work items and to receive the second work items from the second separate database wherein the processor is to store the received second work items in the first-in-first-out buffer.

10. The computer system of claim 1, further comprising a calendar storage to store multiple calendar work items, each of the calendar work items being associated with a start time and an end time.

11. The computer system of claim 1, further comprising a third input port to receive completion data associated with a completed work item and the processor is to perform the steps of retrieving, selecting and storing in response to receiving the completion data.

12. A computer-implemented method for creating a work sequence of work items, the method comprising:
receiving from a linked list storage a linked list of multiple first work items comprising links between the first work items such that the links represent a completion dependency between the first work items;
receiving a first-out unscheduled second work item from a first-in-first-out buffer of multiple unscheduled second work items, each of the unscheduled second work items being associated with a duration;
selecting two of the first work items such that an available time between the two of the first work items is greater or equal to the duration of the first-out unscheduled second work item, and
storing in the linked list storage a link between the first-out unscheduled work item and each of the two selected first work items such that the stored link defines a work sequence and the first-out unscheduled work item is between the two first work items in the work sequence.

13. A non-transitory computer readable medium, including computer-executable instructions stored thereon that when executed by a processor, causes the processor to perform the method of claim 1.

14. A computer system for displaying a work sequence, the computer system comprising:
a linked list storage to store first work items and links between the first work items such that the links represent a completion dependency between the first work items;
a first-in-first-out buffer to buffer unscheduled second work items defining a first-out unscheduled second work item, each of the unscheduled second work items being associated with a duration;
a processor
to retrieve the first-out unscheduled second work item from the buffer,
to select two of the first work items such that an available time between the two of the first work items is greater or equal to the duration of the first-out unscheduled second work item, and
a display
to display a graphical representation of the first-out unscheduled work item located in relation to a graphical representation of each of the two selected first work item such that the location defines a work sequence and the first-out unscheduled work item is between the two first work items in the work sequence.

15. A method for displaying a work sequence, the method comprising:
receiving from a linked list storage a linked list of multiple first work items comprising links between the first work items such that the links represent a completion dependency between the first work items;
receiving a first-out unscheduled second work item from a first-in-first-out buffer of multiple unscheduled second work items, each of the unscheduled second work items being associated with a duration;
selecting two of the first work items such that an available time between the two of the first work items is greater or equal to the duration of the first-out unscheduled second work item, and
displaying a graphical representation of the first-out unscheduled work item located in relation to a graphical representation of each of the two selected first work item such that the location defines a work sequence and the first-out unscheduled work item is between the two first work items in the work sequence.

16. A non-transitory computer readable medium, including computer-executable instructions stored thereon that when executed by a processor, causes the processor to perform the method of claim 15.
